(19) United States
(12) Patent Application Publication
(10) Pub. No.: US 2015/0063782 A1
(43) Pub. Date: Mar. 5, 2015

(54) Electronic Apparatus, Control Method, and Computer-Readable Storage Medium

(71) Applicant: Kabushiki Kaisha Toshiba, Tokyo (JP)

(72) Inventors: Michio Yamashita, Inagi-shi (JP); Hiroaki Ito, Ome-shi (JP); Tomoki Nakagawa, Akiruno-shi (JP)

(73) Assignee: Kabushiki Kaisha Toshiba, Tokyo (JP)

(21) Appl. No.: 14/181,475

(22) Filed: Feb. 14, 2014

(30) Foreign Application Priority Data
Sep. 4, 2013 (JP) 2013-182908

(51) Int. Cl. H04N 21/482; H04N 9/87

(52) U.S. Cl. CPC H04N 21/4828; H04N 9/87
USPC 386/243

(57) ABSTRACT

According to an embodiment, an electronic apparatus includes a processor and a display controller. The processor is configured to acquire keywords from program information of a program being displayed on a screen. The display controller is configured to display the keywords arranged to be selectable on the screen and to display, if a first keyword is selected from the keywords, a first scene information regarding a first scene, a caption of the first scene including the first keyword.

### CROSS-REFERENCE TO RELATED APPLICATIONS

This application is based upon and claims the benefit of priority from prior Japanese Patent Application No. 2013-182908, filed Sep. 4, 2013, the entire contents of which are incorporated herein by reference.

### FIELD

Embodiments described herein relate generally to an electronic apparatus, a control method, and a computer-readable storage medium.

### BACKGROUND

There are electronic apparatuses such as a video information recorder having a function of automatically recording all programs carried on a channel and in a time slot designated by the user.

However, since a large number of programs are recorded by the above function, it is difficult for the user to search for a desired program or a scene included in a program.

There has been a need for enabling a user to search for a recorded program or a scene included in the program.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a schematic structure of a video information recorder according to an embodiment;

FIG. 2 is a block diagram showing a function of the video information recorder according to the embodiment;

FIG. 3 is a flowchart for explanation of an operation of a caption processor according to the embodiment;

FIG. 4 is an illustration showing an example of a data structure of a caption keyword record according to the embodiment;

FIG. 5 is an illustration showing an example of a data structure of a keyword-classification dictionary according to the embodiment;

FIG. 6 is a flowchart for explanation of an operation of an EPG processor according to the embodiment;

FIG. 7 is an illustration showing an example of a data structure of an EPG keyword record according to the embodiment;

FIG. 8 is a flowchart for explanation of a reproduction procedure of a recorded program according to the embodiment;

FIG. 9 is an illustration showing an example of a data structure of a genre-classification dictionary according to the embodiment;

FIG. 10 is an illustration showing an example of a keyword list according to the embodiment; and

FIG. 11 is an illustration showing an example of a scene list according to the embodiment.

### DETAILED DESCRIPTION

Various embodiments will be described hereinafter with reference to the accompanying drawings.

In general, according to an embodiment, an electronic apparatus includes a processor and a display controller. The processor is configured to acquire keywords from program information of a program being displayed on a screen. The display controller is configured to display the keywords arranged to be selectable on the screen and to display, if a first keyword is selected from the keywords, a first scene information regarding a first scene, a caption of the first scene including the first keyword.

In the present embodiment, a video information recorder capable of recording and reproducing a broadcast program is disclosed as an example of an electronic apparatus.

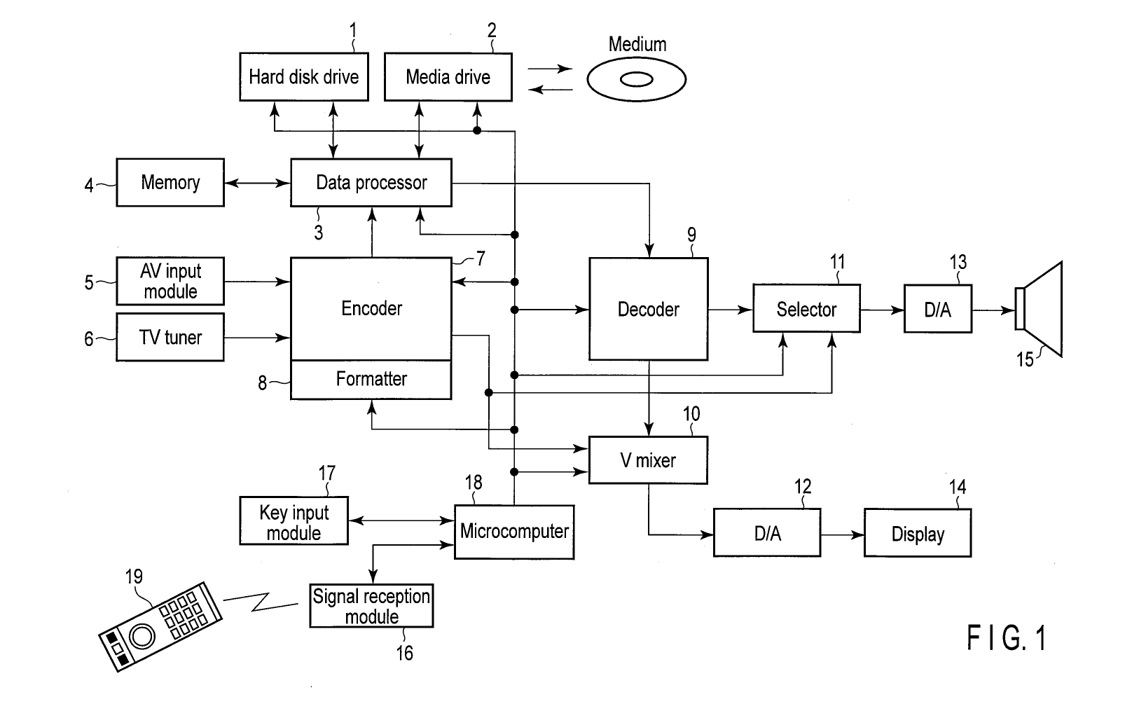

FIG. 1 is a block diagram showing a schematic structure of the video information recorder. The video information recorder includes a hard disk drive 1 and a media drive 2 as a storage device capable of writing and reading content such as a program. The video information recorder may include either of the hard disk drive 1 and the media drive 2, or may include a storage medium, etc., including a semiconductor memory in addition to these or instead of these. The media drive 2 carries out reading and writing of information from and to, for example, an optical disk medium conforming to the DVD standard, the Blu-ray (registered trademark) standard, etc.

The video information recorder includes a data processor 3 as an element for controlling writing and reading of data using the hard disk drive 1 and the media drive 2. The data processor 3 is connected with a nonvolatile memory 4 storing a computer program, etc. The data processor 3 executes various processes in accordance with a computer program stored in the memory 4. The data processor 3 may use the memory 4 as a work area necessary for execution of a computer program.

The video information recorder includes an AV input module 5, a TV tuner 6, an encoder 7 and a formatter 8 as an element for storing video mostly.

The AV input module 5 supplies the encoder 7 with a digital video signal and a digital audio signal input from, for example, an apparatus connected to the outside. The TV tuner 6 carries out tuning (channel selection) of a digital broadcast signal stream supplied from an antenna connected to the outside. The TV tuner 6 supplies the encoder 7 with a tuned digital broadcast signal stream. The digital broadcast signal stream includes a video signal, an audio signal, a caption signal, an electronic program guide (EPG) signal, etc. The caption signal is a signal corresponding to a so-called closed caption which is displayed or not displayed on video in a switchable manner. The EPG signal indicates electronic program information. The electronic program information includes data indicating a program ID specific to each program, a title of a program, a broadcasting date and time of a program, a broadcasting station of a program, an outline of a program, a genre of a program, a cast of a program, a program symbol, etc. The program symbol indicates an attribute of a program such as a new program, a final episode, a live broadcast, a rebroadcast, a captioned broadcast, etc.

In the present embodiment, a case in which signals input from the AV input module 5 and the TV tuner 6 are digital is explained; however, each signal may be analogue. If each signal is analogue, an A/D converter for converting the signal into a digital signal is provided in the encoder 7, etc.

The encoder 7 converts, for example, video signals input from the AV input module 5 and the TV tuner 6 into digital video signals compressed in accordance with a standard such as Moving Picture Experts Group (MPEG) 1 and MPEG 2, and supplies them to the formatter 8. In addition, the encoder 7 converts, for example, audio signals input from the AV input module 5 and the TV tuner 6 into digital audio signals compressed in accordance with a standard such as MPEG or audio compression (AC)-3, and supplies them to the formatter 8. Moreover, the encoder 7 supplies the data processor 3 with a caption signal and an EPG signal included in a digital broadcast signal stream input from the TV tuner 6. If a compressed digital video signal and a compressed digital audio signal are input, the encoder 7 may supply the video signal and the audio signal directly to the formatter 8. The encoder 7 can also supply a digital video signal and a digital audio signal directly to a video (V) mixer 10 and a selector 11 to be described later, respectively.

The formatter 8 creates a packetized elementary stream (PES) for a digital video signal, a digital audio signal and a digital caption signal supplied from the encoder 7. Moreover, the formatter 8 aggregates created PESs on respective signals and converts them into a format of a prescribed video-recording (VR) standard. The formatter 8 supplies data created by the conversion to the data processor 3. The data processor 3 supplies data supplied from the formatter 8 to the hard disk drive 1 or the media drive 2, and the data can be saved on a hard disk or an optical disk medium.

The video information recorder includes a decoder 9, the video (V) mixer 10, the selector 11 and D/A converters 12 and 13 as an element for reproducing video mostly.

The data processor 3 supplies, for example, data saved on the hard disk drive 1 or data read from an optical disk medium by the media drive 2 to the decoder 9.

The decoder 9 extracts PESs on video, audio and a caption from data supplied from the data processor 3, and decodes extracted PESs into a video signal, an audio signal and a caption signal, respectively. The decoder 9 outputs a decoded video signal and a decoded caption signal to the V mixer 10, and outputs a decoded audio signal to the selector 11.

The V mixer 10 synthesizes a text signal such as a caption signal for a video signal supplied from the decoder 9, etc. The V mixer 10 may also synthesize a video signal of a screen under on-screen display (OSD) control for a video signal supplied from the decoder 9, etc. The V mixer 10 outputs a synthesized video signal to the D/A converter 12.

The D/A converter 12 converts a digital video signal input from the V mixer 10 into analogue, and outputs the signal to a display 14 (screen) of a television device, etc. The display 14 displays an image based on an input video signal.

The selector 11 selects a signal to be output as audio from an audio signal input from the decoder 9 and an audio signal directly input from the encoder 7. The selector 11 outputs a selected signal to the D/A converter 13.

The D/A converter 13 converts a digital audio signal input from the selector 11 into analogue, and outputs the signal to a speaker 15. The speaker 15 outputs audio according to an input audio signal.

The video information recorder includes a signal reception module 16, a key input module 17 and a microcomputer 18 as an element for inputting instructions from a user and controlling each module in accordance with input instructions.

The key input module 17 includes a key for inputting various instructions concerning recording and reproduction, etc., of a program. The key input module 17 outputs a signal according to an operated key to the microcomputer 18.

The signal reception module 16 receives a signal wirelessly transmitted from a remote controller 19. The remote controller 19 includes various buttons concerning recording and reproduction, etc., of a program, and transmits wirelessly a signal corresponding to a button operated by the user. The signal reception module 16 outputs a signal received from the remote controller 19 to the microcomputer 18.

The microcomputer 18 includes a read-only memory (ROM) with a computer program, etc., written thereon, a micro-processing unit (MPU) or a central processing unit (CPU) which executes a computer program written on the ROM, and a random access memory (RAM) which provides a work area necessary for execution of a computer program. The microcomputer 18 controls the hard disk drive 1, the media drive 2, the data processor 3, the encoder 7, the formatter 8, the decoder 9, the V mixer 10, the selector 11, etc., in accordance with a signal input from the key input module 17 and a signal received by the signal reception module 16.

The video information recorder of the present embodiment includes an automatic recording function of automatically recording all programs broadcast on a channel or in a time slot designated by the user. Moreover, the video information recorder includes a scene search function of searching a recorded program for a scene whose caption includes a keyword designated by the user.

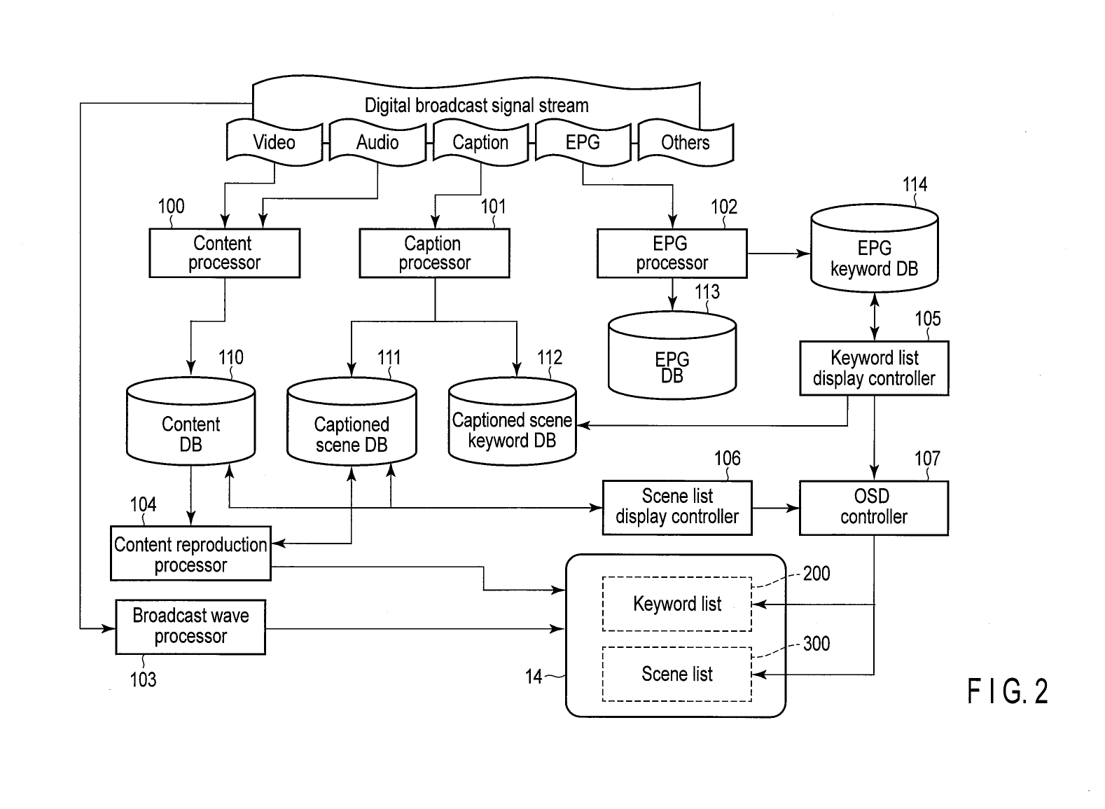

FIG. 2 is a block diagram showing a structure related to these functions. The video information recorder includes a content processor 100, a caption processor 101, an EPG processor 102, a broadcast wave processor 103, a content reproduction processor 104, a keyword list display controller 105 (first display controller), a scene list display controller 106 (second display controller), an OSD controller 107, a content data base (DB) 110, a captioned scene DB 111, a captioned scene keyword DB 112, an EPG DB 113 and an EPG keyword DB 114.

Each of the processor and controller modules 100 to 107 is realized, for example, when a control element such as the data processor 3 and the microcomputer 18 executes a computer program and cooperates with a hardware module which the video information recorder includes. Each of the DBs 110 to 114 is stored in, for example, the hard disk drive 1. Each of the DBs 110 to 114 may be stored in an optical disk medium which the media drive 2 can write and read data to and from. Each of the processor and controller modules 100 to 107 may include a dedicated processor and a hardware module.

The content processor 100, for example, saves data corresponding to a video signal and an audio signal included in a digital broadcast signal stream of a channel predesignated by the user in a time slot predesignated by the user in the content DB 110. Hereinafter, data saved in the content DB 110 will be referred to as content data. The content data is, for example, data converted into a format of the aforementioned VR standard in the formatter 8.

The caption processor 101, for example, saves data corresponding to a caption signal included in a digital broadcast signal stream of a channel predesignated by the user in a time slot predesignated by the user in the captioned scene DB 111. Hereinafter, data saved in the captioned scene DB 111 will be referred to as captioned scene data. The captioned scene data is, for example, data converted into a format of the aforementioned VR standard in the formatter 8, and includes a program ID of a program for which a caption is to be displayed, character-string information indicating a character string of a caption, and display time information indicating display time of a caption. The display time information includes a display start time and a display end time of a caption. The display start time and the display end time can be represented by using, for example, notation of Universal Coordinated Time (UTC), Japan Standard Time (JST), etc., or an elapsed reproduction time from the head of a program.

In addition, the caption processor 101 extracts a keyword from a caption character string indicated by captioned scene data saved in the captioned scene DB 111, and creates a record related to an extracted keyword in the captioned scene keyword DB 112. Hereinafter, a record created in the captioned scene keyword DB 112 will be referred to as a caption keyword record.

The EPG processor 102, for example, saves data corresponding to an EPG signal included in a digital broadcast signal stream of a channel predesignated by the user in a time slot predesignated by the user in the EPG DB 113. Hereinafter, data saved in the EPG DB 113 will be referred to as EPG data. The EPG data indicates the aforementioned electronic program information.

In addition, the EPG processor 102 extracts a keyword from a character string indicated by EPG data saved in the EPG DB 113, and creates a record related to an extracted keyword in the EPG keyword DB 114. Hereinafter, a record created in the EPG keyword DB 114 will be referred to as an EPG keyword record.

The broadcast wave processor 103 captures a video signal and an audio signal from a digital broadcast signal stream corresponding to a channel selected by the user through an operation of the remote controller 19, etc. The broadcast wave processor 103 causes the display 14 to display video according to a captured video signal, and causes the speaker 15 to output audio according to a captured audio signal. If the user switches display of a caption on through an operation of remote controller 19, etc., the broadcast wave processor 103 causes the display 14 to display a caption according to a caption signal included in a digital broadcast signal stream.

The content reproduction processor 104 reproduces a recorded program. That is, the content reproduction processor 104 causes the display 14 to display video according to a video signal included in content data saved in the content DB 110, and causes the speaker 15 to output audio according to an audio signal included in the content data. The content reproduction processor 104 may also cause the display 14 to display a caption indicated by captioned scene data saved in the captioned scene DB 111 in synchronization with reproduction of content data saved in the content DB 110.

The keyword list display controller 105 creates image data of a keyword image in which a keyword corresponding to a caption keyword record saved in the captioned scene keyword DB 112 or a keyword corresponding to an EPG keyword record saved in the EPG keyword DB 114 is arranged to be selectable. A keyword image of the present embodiment is, for example, a keyword list 200 in which keywords are arranged in accordance with a predetermined condition (see FIG. 10).

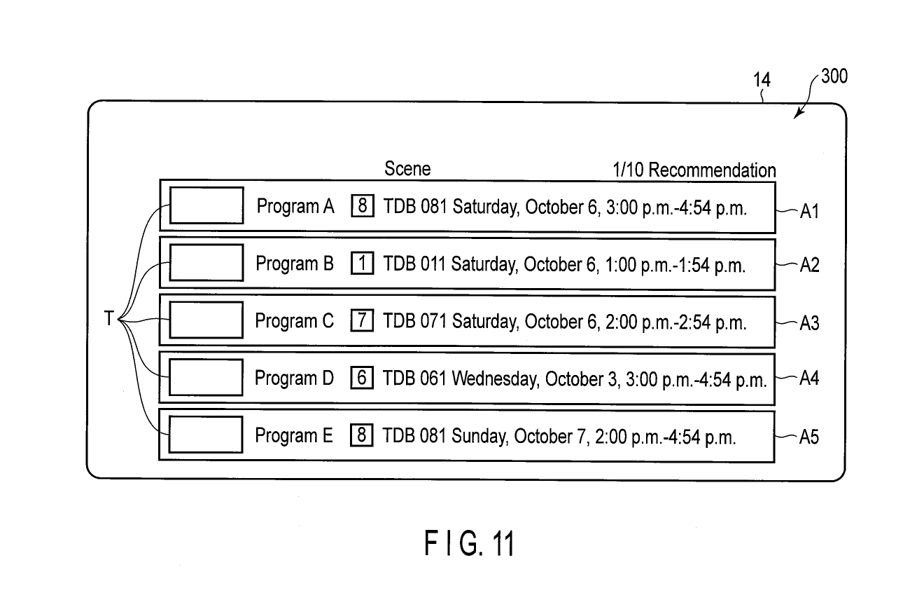

The scene list display controller 106 extracts a scene whose caption includes a keyword selected from the keyword list 200 from a recorded program, and creates image data of a scene image in which an extracted scene is shown to be selectable. A scene image of the present embodiment is, for example, a scene list 300 in which information items on scenes (scene information) are arranged in accordance with a predetermined condition (see FIG. 11).

The OSD controller 107 displays the keyword list 200 according to image data created by the keyword list display controller 105 and the scene list 300 according to image data created by the scene list display controller 106 on video being displayed on the display 14.

Hereinafter, an operation of each of the processor and controller modules 100 to 107 shown in FIG. 2 will be described in detail.

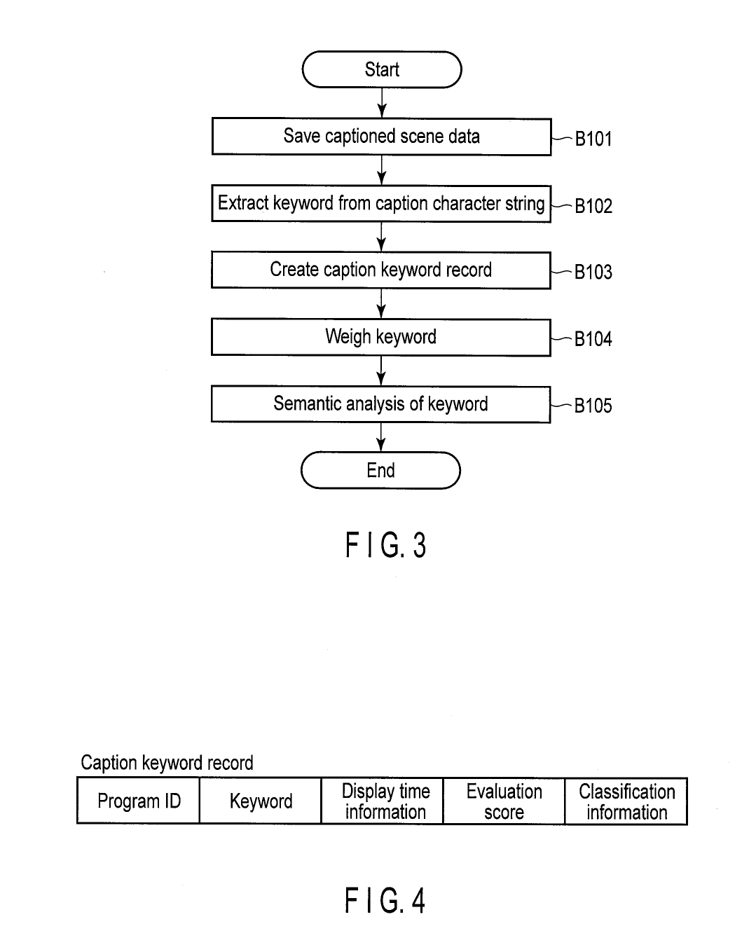

First, a process in which the video information recorder saves content data by the aforementioned automatic recording function will be described with reference to FIGS. 3 to 7.

If the automatic recording function is turned on, the content processor 100 saves content data of all programs broadcast on a channel designated by the user in a time slot designated by the user in the content DB 110. Meanwhile, the caption processor 101 executes the processes shown in the flowchart of FIG. 3. The processes shown in the flowchart are, for example, processes for a caption of one scene. That is, the caption processor 101 executes the processes shown in the flowchart for each of captions corresponding to respective scenes of a program successively.

First, the caption processor 101 saves captioned scene data corresponding to a caption signal included in a digital broadcast signal stream in the captioned scene DB 111 (block B101).

Moreover, the caption processor 101 extracts a keyword from a caption character string included in captioned scene data saved in the captioned scene DB 111 (block B102). A keyword can be extracted by, for example, carrying out a morphological analysis of a caption character string. A keyword can be, for example, a noun (a common noun, a proper noun or both of them). The caption processor 101 creates a caption keyword record related to an extracted keyword in the captioned scene keyword DB 112 (block B103).

FIG. 4 shows an example of a data structure of a caption keyword record. A caption keyword record includes a program ID of a program corresponding to a caption from which a keyword is extracted, a keyword extracted from the caption, display time information of the caption, an evaluation score and classification information. An evaluation score is written in block B104 to be described later. Classification information is written in block B105 to be described later.

After block B103, the caption processor 101 weighs a keyword extracted in block B102 (block B104). More specifically, the caption processor 101 calculates an evaluation score on a predetermined evaluation criterion for an extracted keyword.

As the evaluation criterion, for example, various criteria such as the following can be adopted: (1) the frequency of occurrence of a keyword extracted in block B102 in a program corresponding to a caption from which a keyword is extracted; (2) the frequency with which the keyword was selected from the keyword list 200 by the user previously; (3) whether or not the keyword corresponds to a full name of a person, a name of group, a stage name, a pseudonym, a pen name, or an abbreviation of these (hereinafter, referred to as a full name, etc.); (4) whether or not the keyword is a number; (5) whether or not the keyword is described in a dictionary file saved on the hard disk drive 1, etc., in advance; (6) the viewing frequency in each broadcasting time slot; and (7) the viewing frequency on each channel.

The frequency of criterion (1) can be defined as the proportion of the number of records including a keyword extracted in block B102 to the number of caption keyword records already created for a program corresponding to a caption from which a keyword is extracted. The frequency of criterion (2) can be defined as the proportion of the number of times a keyword extracted in block B102 was selected to the number of times a keyword was selected from the keyword list 200 by the user previously. Whether or not a keyword extracted in block B102 corresponds to the full name of criterion (3) can be determined by, for example, whether or not the keyword extracted in block B102 includes a character string corresponding to a family name and a given name. Alternatively, if a dictionary file in which the full names, etc., of performers and celebrities are described is saved on the hard disk drive 1, etc., in advance and a keyword extracted in block B102 is described in the dictionary file, it may be determined that the keyword is the full name, etc. The frequency of criterion (6) can be defined as the proportion of viewing time in a time slot of display time of a caption from which a keyword is extracted to the entire time the user spent for viewing previously. The frequency of criterion (7) can be defined as the proportion of viewing time of a channel of a program corresponding to a caption from which a keyword is extracted to viewing time of all the programs the user viewed previously.

If the frequency of criterion (1) or (2) is adopted as the aforementioned evaluation criterion, for example, the higher these frequencies are, the higher an evaluation score can be made. If criterion (3) is adopted as the aforementioned evaluation criterion, an evaluation score can be made high, for example, if a keyword corresponds to a full name, etc. If criterion (4) is adopted as the aforementioned evaluation criterion, considering that a number is seldom a keyword, an evaluation score can be made low, for example, if a keyword corresponds to a number. If criterion (5) is adopted as the aforementioned evaluation criterion, an evaluation score can be made high, for example, if a keyword is included in a dictionary file. If criterion (6) is adopted as the aforementioned evaluation criterion, an evaluation score can be made high, for example, in the case of a time slot which an audience views with a high frequency. If criterion (7) is adopted as the aforementioned evaluation criterion, an evaluation score can be made high, for example, in the case of a channel which an audience views with a high frequency.

The caption processor 101 writes a calculated evaluation score to a caption keyword record created in the captioned scene keyword DB 112 in block B103. An evaluation score may be calculated based on a plurality of evaluation criteria. In this case, an evaluation score written to a caption keyword record can be the sum of evaluation scores calculated by the respective evaluation criteria.

After block B104, the caption processor 101 carries out a semantic analysis of a keyword extracted in block B102 (block B105). More specifically, the caption processor 101 identifies classification information on the keyword based on a keyword-classification dictionary 400 having, for example, such a data structure as is shown in FIG. 5. The keyword-classification dictionary 400 associates keywords such as “yen's appreciation”, “prime minister”, “home run” and “piano” with classification information such as “economy”, “politics”, “sport” and “instrument” which indicates the categories these keywords belong to. The keyword-classification dictionary 400 is saved on, for example, the hard disk drive 1 in advance. The caption processor 101 identifies classification information associated with a keyword extracted in block B102 from the keyword-classification dictionary 400, and writes identified classification information to a caption keyword record created in the captioned scene keyword DB 112 in block B103.

The caption processor 101 terminates the processes shown in the flowchart with block B105. If a plurality of keywords are extracted from a caption character string of one scene in block B102, the caption processor 101 executes the processes of blocks B103 to B105 for each of the plurality of keywords.

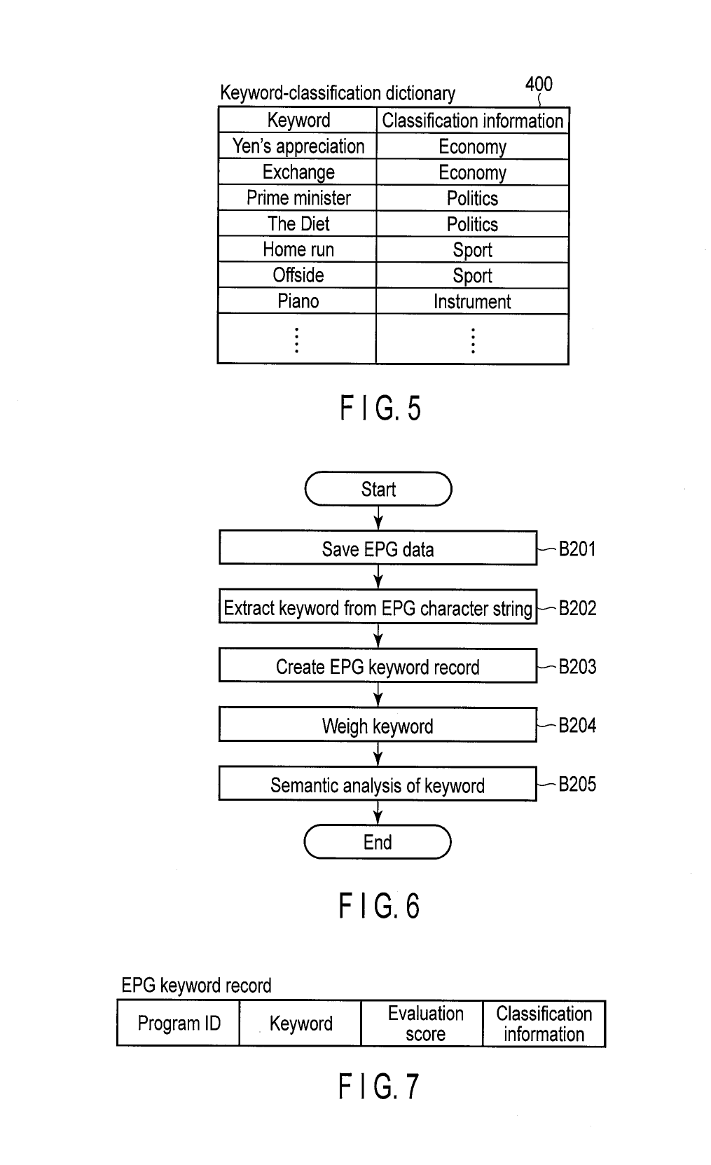

While the content processor 100 is continuously saving content data in the content DB 110 by the aforementioned automatic recording function, the EPG processor 102 executes the processes shown in the flowchart of FIG. 6. The processes shown in the flowchart are, for example, processes for electronic program information on one program.

First, the EPG processor 102 saves EPG data corresponding to an EPG signal included in a digital broadcast signal stream in the EPG DB 113 (block B201).

Moreover, the EPG processor 102 extracts a keyword from electronic program information indicated by EPG data saved in the EPG DB 113 in block B201 (block B202). A keyword can be extracted by, for example, carrying out a morphological analysis of a character string indicating a title and an outline of a program included in electronic program information. A keyword can be, for example, a noun (a common noun, a proper noun or both of these). A keyword also can be a character string indicating a cast included in electronic program information.

Electronic program information may include tag information such as “notice” and “attention”. The tag information is often not related to a program. Thus, a character string indicating the tag information may be excluded from an object from which a keyword is extracted.

The EPG processor 102 creates an EPG keyword record related to a keyword extracted in block B202 in the EPG keyword DB 114 (block B203).

FIG. 7 shows an example of a data structure of an EPG keyword record. An EPG keyword record includes a program ID included in EPG data from which a keyword is extracted, a keyword extracted from the EPG data, an evaluation score and classification information. An evaluation score is written in block B204 to be described later. Classification information is written in block B205 to be described later.

After block B203, the EPG processor 102 weighs a keyword extracted in block B202 (block B204). More specifically, the EPG processor 102 calculates an evaluation score on a predetermined evaluation criterion for an extracted keyword. As the evaluation criterion, for example, evaluation criteria (1) to (7) which have been explained with respect to block B104, etc., can be adopted. A technique for calculating an evaluation score on these evaluation criteria is as described earlier. The EPG processor 102 writes a calculated evaluation score to an EPG keyword record created in the EPG keyword DB 114 in block B203.

After block B204, the EPG processor 102 carries out a semantic analysis of a keyword extracted in block B202 (block B205). A technique for the semantic analysis is the same as that of block B105. That is, the EPG processor 102 identifies classification information associated with a keyword extracted in block B202 based on the keyword-classification dictionary 400, and writes identified classification information to an EPG keyword record created in the EPG keyword DB 114 in block 203.

The EPG processor 102 terminates the processes shown in the flowchart with block B205. If a plurality of keywords are extracted from electronic program information in block 202, the EPG processor 102 executes the processes of blocks 203 to 205 for each of the plurality of keywords.

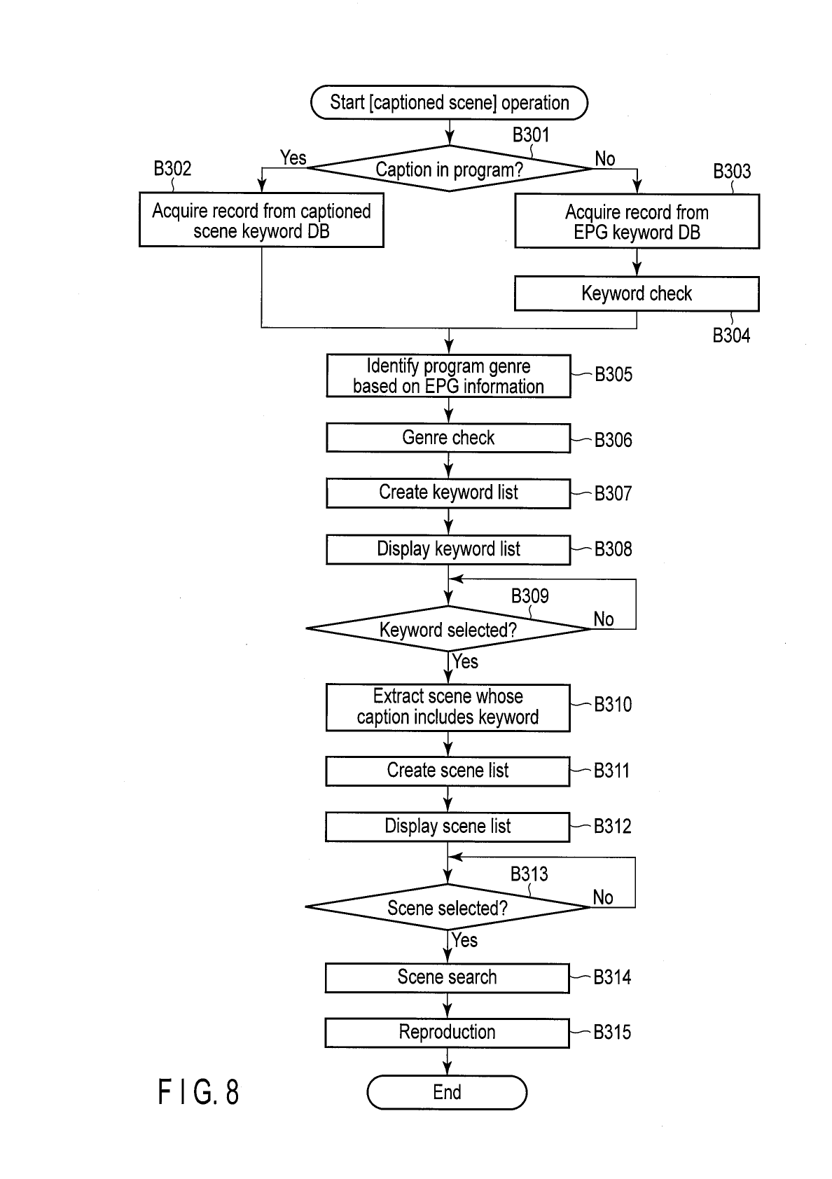

Next, a process of searching for a scene desired by the user with a keyword by the aforementioned scene search function and reproducing a scene selected by the user from found scenes will be described with reference to FIGS. 8 to 11.

If the user presses a “captioned scene” button provided at the remote controller 19 and the signal reception module 16 receives a signal corresponding to the button while some program is being displayed on the display 14, the content reproduction processor 104, the keyword list display controller 105, the scene list display controller 106 and the OSD controller 107 carry out the processes shown in the flowchart of FIG. 8 in cooperation with each other.

First, the keyword list display controller 105 determines whether or not a caption is in a program now being displayed on the display 14 (block B301). For example, in a case in which the broadcast wave processor 103 causes the display 14 to display video according to a video signal included in a digital broadcast signal stream, the keyword list display controller 105 determines that a caption is in a program if a caption signal is included in the stream, and determines that a caption is not in a program if a caption signal is not included in the stream. In addition, in a case in which the content reproduction processor 104 causes the display 14 to display video based on content data saved in the content DB 110, the keyword list display controller 105 determines that a caption is in a program if captioned scene data including a program ID of a recorded program corresponding to the content data is saved in the captioned scene DB 111, and determines that a caption is not in a program if the captioned scene data is not saved.

If it is determined that a caption is in a program in block B301 (Yes in block B301), the keyword list display controller 105 acquires a caption keyword record including a program ID of a program the user is viewing from the captioned scene keyword DB 112 (block B302). Here, the “program the user is viewing” includes not only a program whose video is displayed on the display 14 by the broadcast wave processor 103 in accordance with a real-time broadcast wave stream but a recorded program whose video is displayed on the display 14 by the content reproduction processor 104. If a plurality of caption keyword records including a program ID of a program the user is viewing exist in the captioned scene keyword DB 112, the keyword list display controller 105 acquires all of them. In addition, in block B302, if broadcasting of a program the user is viewing has already been finished and the processes by the caption processor 101 for all the scenes of the program have been completed, acquisition of a caption keyword record can be carried out for the captions of all the scenes of the program. On the other hand, if a program the user is viewing is a program being broadcast, acquisition of a caption keyword record can be carried out for the captions included from the head of the program to a scene where the processes by the caption processor 101 are completed.

If it is determined that a caption is not in a program in block B301 (No in block B301), the keyword list display controller 105 acquires an EPG keyword record including a program ID of a program the user is viewing from the EPG keyword DB 114 (block B303). If a plurality of keyword records including a program ID of a program the user is viewing exist in the EPG keyword DB 114, the keyword list display controller 105 acquires all of them.

A keyword extracted from electronic program information may not be included in a caption of a recorded program. Thus, the keyword list display controller 105 checks whether or not a caption keyword record including the same keyword as that included in an EPG keyword record acquired in block B303 exists in the captioned scene keyword DB 112 (block B304). If a plurality of EPG keyword records are acquired in block B303, the keyword list display controller 105 executes the process of block B304 for all the EPG keyword records. The keyword list display controller 105 excludes an EPG keyword record including a keyword which is not included in any caption keyword record from an object of further processes.

After block B302 or block B304, the keyword list display controller 105 identifies a genre of a program the user is viewing (block B305). More specifically, the keyword list display controller 105 accesses EPG data which is saved in the EPG DB 113 and includes a program ID of a program the user is viewing. The keyword list display controller 105 identifies a genre of the program by referring to data indicating a genre included in the EPG data.

Next, the keyword list display controller 105 carries out a genre check of a caption keyword record which has been acquired in block B302 or an EPG keyword record which has been acquired in block B303 and has not been excluded in the check of block B304 (block B306).

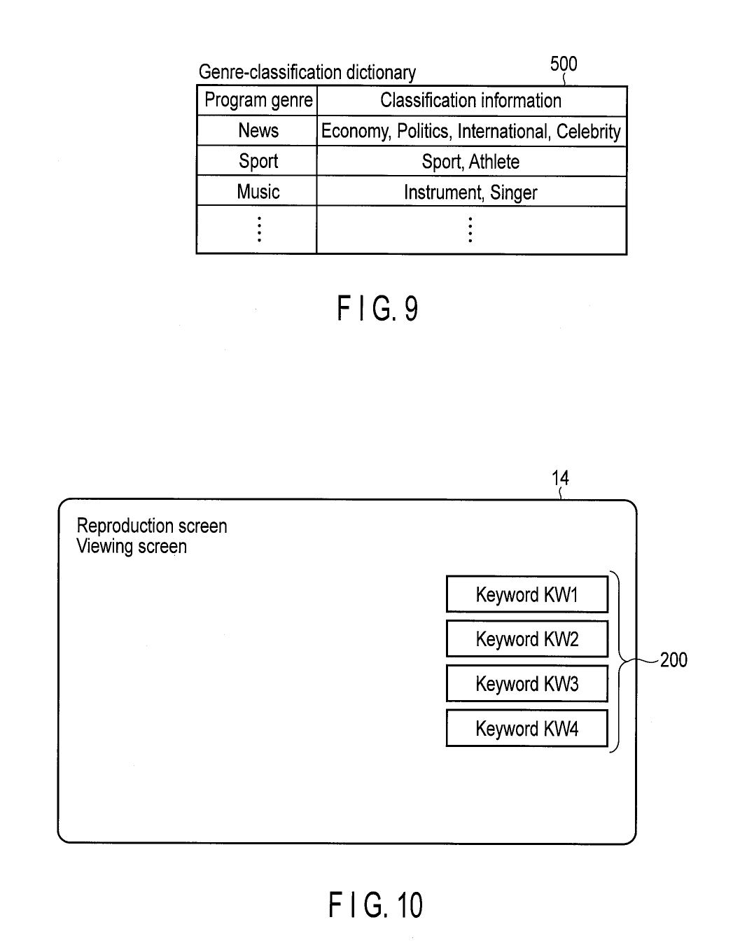

A genre check is a process of narrowing down caption keyword records or EPG keyword records by using a genre-classification dictionary 500 having, for example, such a data structure as is shown in FIG. 9. The genre-classification dictionary 500 associates a genre of a program such as “news”, “sport” and “music” with classification information such as “economy”, “sport” and “instrument”. A genre may be associated with a classification information item or a plurality of classification information items. The genre-classification dictionary 500 is saved on, for example, the hard disk drive 1 in advance.

For example, if block B306 is carried out after blocks B302 and B305, the keyword list display controller 105 determines whether classification information included in a caption keyword record acquired in block B302 is associated with a genre of a program identified in block B305 in the genre-classification dictionary 500. The keyword list display controller 105 excludes a caption keyword record whose classification information and genre of a program are not associated with each other from an object of further processes.

In addition, if block B306 is carried out after blocks B303 to B305, the keyword list display controller 105 determines whether classification information included in an EPG keyword record not excluded in block B304 and a genre of a program identified in block B305 are associated with each other in the genre-classification dictionary 500. The keyword list display controller 105 excludes an EPG keyword record whose classification information and genre of a program are not associated with each other from an object of further processes.

After block B306, the keyword list display controller 105 creates image data of the keyword list 200 in which a keyword included in a caption keyword record or an EPG keyword record which has not been excluded in the genre check of block B306 is arranged (block B307).

Moreover, the keyword list display controller 105 commands the OSD controller 107 to display the keyword list 200 based on image data created in block B307. Upon receiving the command, the OSD controller 107 displays the keyword list 200 based on image data created by the keyword list display controller 105 on video being displayed on the display 14 (block B308).

FIG. 10 shows an example of the keyword list 200. The keyword list 200 is an image in which keywords included in a caption keyword record or an EPG keyword record which has not been excluded in the genre check of block B306 are arranged, for example, in a line like keywords KW1 to KW4 shown in the figure. Overlapping keywords may be combined into one keyword.

In the keyword list 200, keywords may be arranged in order of evaluation score. That is, the keyword list 200 displayed after blocks B302 and B305 to B308 is a list in which keywords included in caption keyword records are arranged in order of evaluation score included in the caption keyword records not excluded in the genre check of block B306. On the other hand, the keyword list 200 displayed after blocks B303 to B308 is a list in which keywords included in EPG keyword records are arranged in order of evaluation score included in the EPG keyword records not excluded in the genre check of block B306. A keyword having a low evaluation score and a keyword having an evaluation score lower than a predetermined threshold value may be excluded from an object to be displayed in the keyword list 200.

The user can select a desired keyword from the keyword list 200 by, for example, an operation of the remote controller 19.

In a state in which the keyword list 200 is displayed on the display 14, the keyword list display controller 105 waits for selection of a keyword from the keyword list 200 (block B309). If a keyword is selected from the keyword list 200 (Yes in block B309), the keyword list display controller 105 notifies the scene list display controller 106 of the selected keyword.

Upon receiving notification of a keyword, the scene list display controller 106 extracts a scene whose caption includes the keyword from a recorded program (block B310). In the present embodiment, the scene list display controller 106 achieves the process of block B310 by searching the captioned scene keyword DB 112 for a caption keyword record including the keyword.

After block B310, the scene list display controller 106 creates image data of the scene list 300 in which a scene of a recorded program corresponding to a found caption keyword record is displayed to be selectable (block B311).

Moreover, the scene list display controller 106 commands the OSD controller 107 to display the scene list 300 based on image data created in block B311. Upon receiving the command, the OSD controller 107 displays the scene list 300 based on image data created by the scene list display controller 106 on video being displayed on the display 14 (block B312).

FIG. 11 shows an example of the scene list 300. The scene list 300 includes a scene area A corresponding to a caption keyword record acquired from the captioned scene keyword DB 112 in block B310. FIG. 11 shows five scene areas A1 to A5. The scene area A includes a title (for example, “program A”) of a recorded program corresponding to a program ID included in a caption keyword record, a broadcasting station (for example, “TDB 081”) of the program and a broadcasting date and time (for example, “Saturday, October 6, 3:00 p.m.-4:54 p.m.”) of the program. When creating image data of the scene list 300, the scene list display controller 106 obtains these title, broadcasting station and broadcasting date and time by, for example, searching the EPG DB 113 using a program ID as a key.

In addition, the scene area A includes a thumbnail T of a scene. The thumbnail T indicates an image of a recorded program in display time information included in a caption keyword record. When creating image data of the scene list 300, the scene list display controller 106 creates a thumbnail T by searching the content DB for a recorded program using a program ID as a key, and reducing an image corresponding to a display start time of the display time information in a found recorded program.

The scene list 300 can include a plurality of pages including different scene areas A. In this case, upon being instructed to switch pages by, for example, an operation of the remote controller 19, the OSD controller 107 switches a scene area A to be arranged in the scene list 300 to a next page or a previous page.

The user can select a desired scene area A from the scene list 300 by, for example, an operation of the remote controller 19.

In a state in which the scene list 300 is displayed on the display 14, the scene list display controller 106 waits for selection of a scene area A from the scene list 300 (block B313). If any scene area A is selected (Yes in block B313), the scene list display controller 106 notifies the content reproduction processor 104 of a program ID of a recorded program corresponding to the selected scene area A and time information of the scene. The time information here is an elapsed reproduction time from the head of a recorded program, and for example, can be a display start time of display time information included in a caption keyword record corresponding to a selected scene area A.

Upon receiving notification of a program ID and time information, the content reproduction processor 104 searches for a reproduction start position of a recorded program (block B314). The reproduction start position is, for example, a scene indicated by the time information in content data corresponding to the program ID saved in the content DB 110.

After block B314, the content reproduction processor 104 starts reproduction of a program (block B315). That is, the content reproduction processor 104 accesses the content DB 110, reads content data successively from the reproduction start position, and causes the display 14 to display video according to a video signal included in read content data. Moreover, the content reproduction processor 104 causes the speaker 15 to output audio according to an audio signal included in read content data.

The processes shown in the flowchart of FIG. 8 is terminated with block B315.

In the present embodiment that has been described above, when viewing a program recorded by an automatic recording function, the user can easily search for a desired program or scene of a program by selecting a keyword arranged in the keyword list 200. Moreover, a keyword arranged in the keyword list 200 is a keyword extracted from a caption or electronic program information of a program the user is viewing, and thus can reflect the user's taste.

By extracting a keyword from electronic program information as in the present embodiment, a keyword can be presented to the user even if the user is viewing a program which does not include a caption.

In the present embodiment, keywords presented to the user are narrowed down based on a genre of a program the user is viewing (block B306). Thus, the keyword list 200 in which a keyword associated with a genre of a program the user is viewing is arranged is presented to the user. Furthermore, in the present embodiment, an evaluation score on a predetermined evaluation criterion is calculated for a keyword extracted from electronic program information, and the keyword list 200 in which keywords are arranged in order of evaluation score is presented to the user. By these techniques, a keyword which accurately reflects the user's taste can be presented.

(Modifications)

Some modifications related to the above embodiment will be described.

In the embodiment, a video information recorder which is an example of an electronic apparatus has been described. However, a structure of the video information recorder disclosed in the embodiment can also be applied to other types of electronic apparatus such as a personal computer.

In the embodiment, viewing and recoding of a digitally broadcast program have been an object to be processed. However, an object to be processed by the video information recorder may include other types of content such as an analog broadcast program, a moving image stored in an optical disk media, etc., and a moving image downloaded via a network.

In block B306 of the embodiment, if classification information of a caption keyword record or an EPG keyword record and a genre of a program the user is viewing are not associated with each other in the genre-classification dictionary 500, the caption keyword record or the EPG keyword record is excluded from an object to be processed from block B307 on. It has been explained that the genre-classification dictionary 500 merely associates a genre of a program with classification information as shown in FIG. 9; however, the genre-classification dictionary 500 may add a score to classification information in accordance with a degree of relevance to a genre. In this case, for example, keywords whose scores according to classification information are high may be arranged in order of score in the keyword list 200.

In the embodiment, a flow of processes in which if a program the user is viewing includes a caption, the keyword list 200 is created by using a keyword extracted from the caption, and if a program the user is viewing does not include a caption, the keyword list 200 is created by using a keyword extracted from electronic program information has been described. However, if a program the user is viewing includes a caption, the keyword list 200 may be created by using not only a keyword extracted from the caption but a keyword extracted from electronic program information. In this case, the order of arrangement in the keyword list 200 may be adjusted by providing a difference in evaluation scores depending on whether a keyword is extracted from a caption or electronic program information.

In the embodiment, the processes for a closed caption as an example of a caption used for extraction of a keyword and search for a scene have been described. However, a caption used for extraction of a keyword and search for a scene may include a so-called open caption unified with video. In this case, a function of performing character recognition from an open caption is provided in a video information recorder. A character string recognized by the character recognition may be added to an object of the processes of blocks B101 to B105.

A computer program for controlling a computer such as a video information recorder to execute functions as the content processor 100, the caption processor 101, the EPG processor 102, the broadcast wave processor 103, the content reproduction processor 104, the keyword list display controller 105, the scene list display controller 106, the OSD controller 107, etc., may be transferred in a state of being preinstalled in a computer or may be transferred in a state of being stored in a non-transitory computer-readable storage medium. In addition, the computer program may be downloaded in a computer via a network.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processor configured to acquire keywords from program information of a program being displayed on a screen;
a display controller configured to display the keywords arranged to be selectable on the screen and to display, if a first keyword is selected from the keywords, a first scene information regarding a first scene, a caption of the first scene including the first keyword.

2. The electronic apparatus of claim 1, wherein:
the program information includes data indicating a genre of the program; and
the display controller is configured to display the keywords associated with a genre indicated by the data.

3. The electronic apparatus of claim 1, wherein:
the display controller is configured to display the keywords in order of scores on a evaluation criterion for the keywords.

4. A control method for an electronic apparatus, comprising:
acquiring keywords from program information of a program being displayed on a screen;
displaying the keywords arranged to be selectable on the screen; and
displaying, if a first keyword is selected from the keywords, a first scene information regarding a first scene, a caption of the first scene including the first keyword.

5. The method of claim 4, wherein:
the program information includes data indicating a genre of the program; and
the displaying comprises displaying the keywords associated with a genre indicated by the data.

6. The method of claim 4 further comprising:
calculating scores on a evaluation criterion for the keywords;
wherein the displaying comprises displaying the keywords in order of the scores.

7. A non-transitory computer readable storage medium having stored thereon a computer program which is executable by a computer, the computer program controls the computer to execute functions of:
acquiring keywords from program information of a program being displayed on a screen;
displaying the keywords arranged to be selectable on the screen; and
displaying, if a first keyword is selected from the keywords, a first scene information regarding a first scene, a caption of the first scene including the first keyword.

8. The storage medium of claim 7, wherein:
the program information includes data indicating a genre of the program; and
the displaying comprises displaying the keywords associated with a genre indicated by the data.

9. The storage medium of claim 7, the computer program controls the computer to further execute function of:
calculating scores on a evaluation criterion for the keywords;
wherein the displaying comprises displaying the keywords in order of the scores.
